(19) United States
(12) Patent Application Publication
(10) Pub. No.: US 2012/0169869 A1
(43) Pub. Date: Jul. 5, 2012

(54) METHOD AND APPARATUS FOR DETERMINING BENDING PROPERTIES OF GOLF CLUB SHAFTS

(75) Inventors: Daniel You, Anaheim, CA (US); Sung G. Jeong, Kum Chon Dong (KR)

(73) Assignee: Daniel You, Anaheim, CA (US)

(21) Appl. No.: 12/982,779

(22) Filed: Dec. 30, 2010

(51) Int. Cl. H04N 7/18; G06K 9/00

(52) U.S. Cl. 348/142; 382/107; 348/E07.085

(57) ABSTRACT

A method and apparatus is provided for determining the bending of a golf club shaft having a first end of the shaft supported between two rollers in a two-point cantilevered mount. The second end of the shaft is deflected a predetermined amount or by a predetermined weight. A digital image is taken of the undeformed and deformed configurations, and the number of pixels between the undeformed and deformed positions is used to calculate one of the deflection, slope, curvature or stiffness of the shaft at various locations on the shaft. For adjustability, the two rollers are relatively positioned. If a deflection mechanism is used on the second shaft end, the deflection mechanism can also be positionable to vary the load on the shaft.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

This invention relates to improved methods and apparatus for determining properties of golf club shafts, such as the bending stiffness and radius of curvature, at various locations along the length of the shaft.

It is useful to know the bending stiffness and curvature of a golf club shaft at various locations along the length of the shaft since the shaft can affect the ball launch angle and ball spin characteristics. Prior methods require complex measurement schemes and calculations, such as U.S. Pat. No. 5,429,008 to Fujikura, which moves a measurement instrument along a horizontal support rod to measure the vertical distance between the horizontal support rod and the bent shaft, and U.S. Pat. No. 4,558,863 to Haas, which measures localized deflections. Prior methods also take time to measure various bending aspects because a weight is suspended from the shaft to cause a shaft deflection and the application of the weight causes the shaft to vibrate. It takes time for the shaft to stop vibrating so accurate measurements can be taken of the shaft position. There is thus a need for an improved and preferably simplified method and apparatus to determine the bending properties of golf clubs.

Prior methods also clamp the shaft in position to form a cantilever support and the clamping can affect the shaft stiffness depending on how the shaft is gripped and the diameter of the gripped portion of the shaft. U.S. Pat. No. 5,515,615 to Twigg shows such a clamp mechanism. There is a need for an improved method and apparatus to consistently hold golf club shafts to determine bending properties.

Other measurement methods fixed the grip end of a shaft horizontally to define an X and Y axis at that grip end. A contact measurement was then used to measure the undeflected shaft location to determine a baseline holding the measuring device, or a non-contacting laser was used to determine the same measurement. The accuracy of the X and Y undeflected data varied with the measuring device's material and strength and varied with the temperature and humidity at the time of the measurement. A weight was hung from the free end of the shaft or the shaft was deflected a predetermined distance, and measurements along the length of the deflected shaft were then measured as above to determine deflected X and Y values along the length of the shaft. The accuracy of the X and Y deflected data varied with the measuring device's material and strength and varied with the temperature and humidity at the time of the measurement. Using differences in the X and Y values from the deflected and undeflected data, and using numerical value differentials, the slope, radius of curvature and bending stiffness is determined. These calculations are based on inaccuracies from two measurements and inaccuracies from the gripping mechanism and inaccuracies from the variability of attaching the load or inaccuracies in the predetermined deflection not causing the predicted load. There is thus a need for an improved method and apparatus to determine the bending properties of golf club shafts.

### BRIEF SUMMARY

An end of a golf club shaft is held between two pins spaced a few inches horizontally apart and spaced vertically apart a short distance apart so as to hold the shaft and its longitudinal centerline horizontal. A roller may be mounted on each pin to reduce friction with the shaft, and the roller may be curved like a pulley to restrain lateral movement of the shaft on the roller while reducing friction. A predetermined force is exerted on the shaft, preferably toward the end of the shaft, causing the shaft to bend. The curvature is photographed to obtain an image of the deflection, preferably using a digital image. The image is used to determine the shaft deflection and curvature at desired locations. The image may be a digital image with the number of pixels between an edge of the shaft in the deformed and undeflected positions used to determine the curvature, deformation and stiffness.

There is thus advantageously provided a test apparatus for golf club shafts which have a grip end opposite a head end and further having a length of the shaft extending between those two ends along a longitudinal axis. The test apparatus includes first and second supports spaced apart along first and second perpendicular axes with the spacing along the first axis is being a few inches or less and the spacing along the second axis being about the diameter of an end of the shaft engaging the first and second supports. Also included is a third support located along the first axis a distance less than a length of the shaft to place the second support between the first and third supports along that first axis. The third support is located a predetermined distance from the second axis to place the second support between the first and third supports along that second axis so that during use a shaft with one end of the shaft placed between the first and second supports can have the other end of the shaft bent over the second support and held in the bent configuration by the third support. Also optionally included is a first position adjustment mechanism connected to one of the first and second supports for adjusting the relative position of the first and second supports along the second axis so that during use an end of the shaft placed between the first and second supports can extend along the second axis with the inclination of the shaft relative to the second axis being adjusted by the first positioning adjustment mechanism. Also included is a digital image recording device offset from the plane of the first and second axes and placed at a location suitable to record the bent configuration of at least a portion of the shaft during use of the apparatus.

The testing apparatus preferably has the first position adjustment mechanism connected to the second support. The apparatus optionally further includes a stop adjacent the first support to limit motion of the shaft along the first axis. This helps consistently position the shaft for consistent testing. The apparatus may also optionally include a force detecting device connected to the third support to detect the force exerted by the shaft on the third support when the shaft is in the bent configuration. A load cell is preferred. A second position adjustment mechanism optionally be connected to the third support for adjusting the position of the third support along the second axis to adjust the magnitude of the bending force on the shaft.

The image recording device is advantageously positioned to record the entire bent shaft during use. Rollers are advantageously placed on a plurality of the supports, with at least one of the rollers further being optionally movable along an axis orthogonal to the first and second axes so the shaft is more easily maintained in a flat plane during bending and testing. Advantageously, there are rollers on the first and second supports which rotate about an axis orthogonal to the first and second axes, with each roller having a groove around a periphery of the roller which groove is selected to have a diameter larger than the diameter of the shaft abutting the groove during use of the testing apparatus, and with at least one of the rollers further being movable along an axis orthogonal to the first and second axes.

The testing apparatus may also optionally include a computer containing an algorithm to determine one of the slope, radius of curvature or stiffness of the shaft at least at one location on the shaft, the algorithm using the number of pixels from the digital image recording device to do so or using information derived from the number of pixels, or using information derived from images of the shaft before and after the deflection for determining the slope, curvature or stiffness. The apparatus preferably includes a computer containing an algorithm to determine the relative deflection of the bent shaft at least at one location, with the relative deflection being between a first undeflected configuration where the shaft is supported by the first and second supports and the bent configuration, the computer using the number of pixels from the digital image recording device.

In a further embodiment, a test apparatus is provided for golf club shafts which have opposing first and second ends and further having a length of the shaft extending between those two ends along a longitudinal axis. The apparatus includes first and second spaced apart support means for supporting the shaft at a first end of the shaft along a first axis during use of the apparatus and means for deflecting the shaft into a bent configuration during use of the apparatus. The two above mentioned rollers from the first embodiment and as described herein may comprise the support means, with the curvature on the rollers being optional. Another roller or pair of rollers on each side of the shaft, located to bend the shaft about the second support, may comprise the deflection means, although a weight, or a weight and pulley arrangement, could also comprise the deflection means, with both the mechanisms described herein. The apparatus also includes means for recoding a digital image of the bent configuration during use of the apparatus, and is described further herein. The image recording means advantageously comprises a digital camera as described later in this disclosure.

This further embodiment may optionally have the means for deflecting the shaft comprise only a displacement mechanism that bends the shaft a predetermined distance from the first axis. The displacement means may include a roller or rollers offset from the undeflected axis of the shaft to cause the shaft to deflect a predetermined distance, as described further herein.

The testing apparatus may further include adjustable means for varying the relative location of the first and second means to vary the inclination of the first axis or adjustable means for varying the location of the third means relative to the second means. Various lead screws, ball screws, rack and gear arrangements, and other adjustment mechanisms are described herein to achieve that adjustment function.

Additionally, the apparatus may include means for detecting the force exerted by the bent shaft on the third means. Load cells, strain gauges, spring scales, and various other force measuring devices are described herein which are suitable for the force detecting means.

The apparatus may also include means for determining the stiffness, slope, deflection or curvature of the shaft using the number of pixels from the means for recording a digital image. This determining means advantageously includes a computing device using an algorithm described herein.

There is also advantageously provided a method for testing a golf club shaft having opposing first and second ends and further having a length of the shaft extending between those two ends along a longitudinal axis. The method includes supporting the shaft at a first end of the shaft along a first axis and deflecting the shaft into a bent configuration. A digital image of the bent configuration is recorded. One of the slope, radius of curvature or stiffness of the shaft at least at one location on the shaft is determined by using the number of pixels in the digital image.

The deflecting step preferably comprises displacing the second end of the shaft a predetermined distance. The deflecting step advantageously comprises displacing the second end of the shaft a predetermined distance and further comprises detecting the amount of force the shaft exerts on a support holding the shaft in the bent configuration. The supporting step advantageously includes supporting the first end of the shaft between two rollers located on opposing sides of the first end of the shaft and offset from each other along a length of the shaft. The supporting step advantageously includes supporting the shaft between two rollers spaced apart vertically and horizontally to provide a two point cantilever support, and further optionally includes varying the relative location of the two rollers to vary the inclination of the longitudinal axis of the shaft supported on those rollers. The method may also include varying the location of the third support relative to each of the two rollers. Additionally, the method may include detecting the force exerted by the bent shaft on the third means.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a plan front view of a testing apparatus using an image recording device;

FIG. 2 is detail perspective view of a positionable roller of FIG. 1;

FIG. 3a is a partial front plan view of a deflection mechanism and load measuring mechanism of FIG. 1 without a shaft;

FIG. 3b is a side plan view of the deflection mechanism and load measuring mechanism of FIG. 3a;

FIG. 3c is a side plan view of the deflection mechanism and load measuring mechanism of FIG. 1 with a shaft;

FIG. 4 is a schematic view of the geometry used to determine properties of the shaft at a location along the deflected shaft of FIG. 1;

FIG. 5 is a flow chart of the test sequence to determine parameters using the bending apparatus of FIG. 1;

FIG. 6a is a front plan view of a testing apparatus as in FIG. 1 but using a weight W to apply a deflecting force;

FIG. 6b is a side plan view of FIG. 6a;

FIG. 7 is a partial view showing a drill bit chuck on the end of a golf club shaft;

FIG. 8 is a plan front view of a testing apparatus using an image recording device as in FIG. 1, but with the golf club shaft in a vertical orientation; and.

FIG. 9 is a plan view of a deformed shaft superimposed on pixels of a sensor in an image recording device.

### DETAILED DESCRIPTION

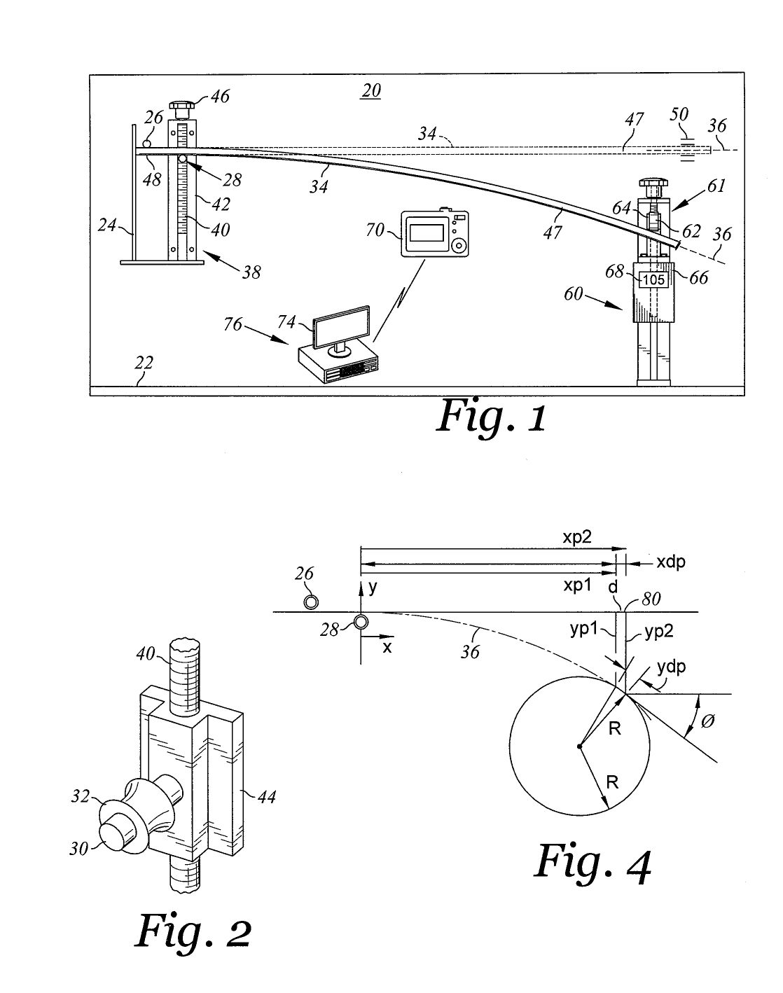

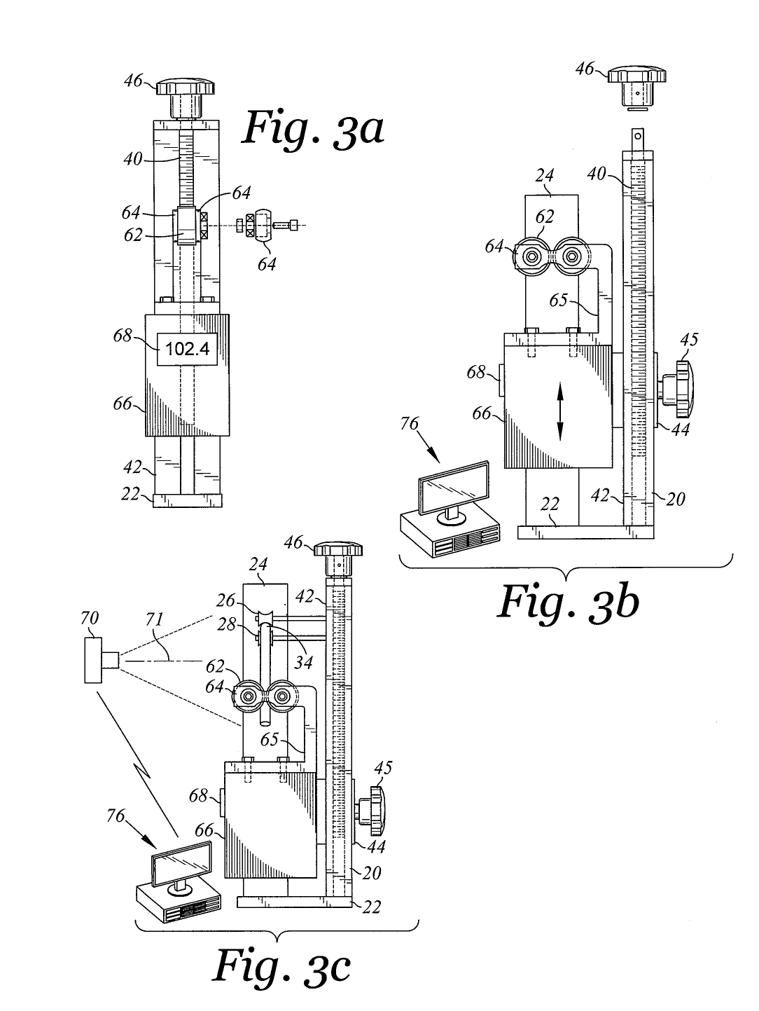

Referring to FIGS. 1 and 3c, a backboard 20 is mounted vertically relative to a horizontal base 22. A position stop 24 extends from one of the base 22 or backboard 20. First and second shaft supports 26, 28 extend from the backboard 20. Each support 26, 28 may include a pin 30 and a roller 32 rotatably mounted on the pin. The pin 30 advantageously extends from the backboard 20, but could be mounted various ways on various brackets or supports. The location of the rollers 32 from the backboard 20 is a trade-off between ease of access, the deflection caused by increasing the distance from the backboard, and the stiffness of the pin 30 or other support for the rollers 32. Advantageously, the pin 30 is short, and the rollers 32 are close to the backboard 20.

The roller 32 may have an inwardly curved or grooved peripheral cross-section much like a pulley, in order to restrain lateral movement of a shaft 34 and to center a longitudinal axis 36 of the shaft 34 on the roller 32 and support 26 or 28. The supports 26, 28 are offset vertically and laterally (horizontally) from each other and located to be on opposing sides of the axis 36 of shaft 34 during use. The axis 36 is preferably, but optionally, horizontal and the following description referring to FIG. 1 is given with respect to that horizontal orientation, especially regarding directional terms such as up or down, and relative terms such as above or below and upper or lower. The first upper support 26 is preferably above the second lower support 28. The first upper support 26 is preferably in a fixed position, while the second, lower support 28 is preferably fastened to an adjustable position mechanism 38 that allows the vertical position of the support 28 to be adjusted. The first and second supports 26, 28 may be spaced any desired distance apart, but are preferably spaced only a few inches apart, ideally about 2-3 inches apart and within four inches of the adjacent end of the shaft 4.

One suitable position adjustment mechanism 38 comprises a lead screw 40 mounted vertically in a bracket 42 that allows rotation of the screw 40 while restraining translation. A collet 44 encircles part or all of the leadscrew 40 and has threads engaged with the lead screw 40 so the collet 44 is drivingly engaged with the lead screw and restrained from rotation by the bracket 42 so the collet 44 translates as the lead screw rotates. The movable lower support 28 is fastened to the collet 44. Advantageously, the collet 44 is elongated along the length of the lead screw 40 to provide a stable support and improved positioning accuracy. A knob 46 on one end of the lead screw 40 allows manual rotation of the lead screw 40 and manual positioning of the position of support 28. A locking knob 45 threadingly engaging the collet 44 and one of the screw or backboard 20 to further lock the collet 44 in position relative to the backboard 20 and screw 46. The adjustment mechanism 38 advantageously varies the position of support 28 along an axis perpendicular to longitudinal axis 36.

During use, a golf club shaft 34 is placed with the club end 47 or the grip end 48 against the stop 24, with the upper side of the shaft 34 abutting the lower side of the first upper support 26 and against the lower side of the associated roller 32. The lower side of the shaft 34 rests on the upper side of the second lower support 28 and on the upper side of the associated roller 32. The position of the adjustable, lower support 38 is adjusted using mechanism 38 so the longitudinal axis 36 of shaft 34 is substantially horizontal. Printed indicia 50 such as an alignment line(s) or marking(s) on the backboard 20 at the stop 24 and adjacent the distal end of the shaft 34 allows visual alignment. Since shaft length will vary the indicia 50 at the distal end of the shaft opposite the stop 24 will have to be repeated to accommodate the anticipated length variation of the shaft. For example, printed indicia 50 comprising a series of parallel, horizontal lines allow centering the distal end of the shaft 34. Exact horizontal alignment is not believed necessary and the alignment indicia 50 are optional.

In the embodiment of FIG. 1, a displacement mechanism 60 is used to bend the shaft 34. The displacement mechanism 60 may include a support 61 which advantageously comprises pair of rollers 62 rollably fastened to shafts connected to an elongated support bracket 64. The rollers 62 extend along and axis perpendicular to the backboard 20 and are spaced apart a distance to center an abutting end of shaft 34 between the rollers. Such rollers are known in the art. The rollers 62 are connected to a force measuring device 66 such as a load cell, strain gauge or other electronic or mechanical or optical or magnetic force detection device or assembly. A load cell is preferred. The force measuring device 66 is fastened to one of the base 22 or backboard 20. The support 61 is positioned below the horizontal axis 36 of the undeflected shaft 34 by a predetermined amount to cause a predetermined amount of force or deflection on the shaft 34.

The rollers 32 on the supports 26, 28 and the rollers 62 on support 61 are preferably aligned along a straight line, and preferably along a line parallel to the plane of backboard 20. Thus, the supports 26, 28 and 61 hold the shaft 34 in a straight line. Two points define a line and preferably the end supports 26 and 61 define that straight line. The roller 32 on lower support 28 is allowed to move to achieve alignment with that line. This can be achieved by placing a bushing on shaft or pin 30 that allows the roller 32 on support 28 to move axially along the length of pin 30 so the roller 32 can move into alignment with the shaft 34. The support 26 could also be configured to move along the length of its pin 30. Likewise, support 61 could be configured to allow rollers 62 or roller support 64 to move. Thus, any of supports 26, 28, 61 could be configured to allow movement along an axis perpendicular to backboard 20 to avoid deforming the shaft 34 in a horizontal plane.

Referring to FIGS. 1, 3a and 3b, the support 61 is optionally vertically positionable using a positioning mechanism 63. The positioning mechanism 63 can vary, and can include the mechanism 38. Since the mechanism 38 is described already, the description is not repeated by the force measuring device 66 is shown as fastened to collet 44 which can be adjustably positioned by screw 40 in bracket 42 by rotating knob 46. A retaining knob 45 optionally holds the collet 44 in place for extra positional accuracy. This can be achieved by moving the entire force measuring device 66 which is attached to the rollers 62, or by moving the support 61 relative to the device 66. Preferably the force measuring device 66 is on a vertically positionable platform or support, and the roller support 64 is rigidly connected to the force measuring device 66. A bracket 65, such as a C bracket, may connect the roller support 64 to the force measuring device 66 so that an end of the shaft 34 can enter the open portion of the C bracket 65 to be placed between the rollers 62. Advantageously, the shaft 34 is centered above the sensor of the force measuring device 66.

During use, a first end of shaft 34 is abutted against stop 24 and the second opposing end of the shaft is bent and placed below support 61 to exert an upward force on force measuring device 66. The testing may be repeated with the ends switched so that the shaft orientation is reversed.

The force measuring device 66 has a display 68 reflecting the amount of force exerted on support 61 by bent shaft 34 which is placed between the rollers 62. The display 68 will vary with the type of force measuring device 66, but preferably comprises a visually readable display.

An image recording device 70, such as a digital camera, is positioned relative to shaft 34 so as to detect and record the deflection of shaft 34. If the horizontal and vertical axes are X and Y, respectively, the image recording device 70 is advantageously located on the X axis between support 26 and 61, and may be located equidistance between supports 28 and 61. The image recording device 70 is advantageously located vertically along the Y axis somewhere between the upper support 26 and the bottom of the rollers 62, and may be located equidistant between the lower support 26 and the bottom of rollers 61. Preferably, though, the image recording device 70 is located adjacent the tip of the shaft 34 in the bent configuration, and ideally about 25 to 75 cm away from the backboard 20 on an axis through the bent end of the shaft 34 and perpendicular to the backboard. The image recording device 70 can be located elsewhere but then accurate location of the bending profile of the shaft 34 may be more difficult to determine and may require correction for optical distortion and optical perspective, and such correction is within the skill in the art. The location of the image recording device 70 as described above is relative to the centerline of its optical axis 71. The backboard 20 may have a regularly spaced grid work or other printed indicia thereon to assist with determining the position of the shaft 34 in the undeflected and/or deflected configurations. The geometry of the image recording device 70 and the shaft 34 before deflection of the shaft is known, and the known geometry can be used to accommodate for optical distortion arising from the lens of the recording device 70.

The location of the image recording device 70 is perpendicular to or orthogonal to the backboard 20 and the plane in which the shaft 34 is located and bent. The location will vary with the optical design of the image recording device 70. A wide angle lens with a short focal length will allow closer placement, a longer focal length will require further placement. The image recording device 70 is offset from the plane containing the first and second (X and Y) axes, and at a location suitable to record the deflection or bent configuration of at least a portion, and preferably all, of the bent or deflected shaft 34.

The recording device 70 is thus advantageously placed so that it can record the deformation of shaft 34 at the location at which the deflection is to be measured. Ideally, the image recording device 70 is located so the optical axis of the recording device is aligned with the location of the position on shaft 34 for which the deformation is to be measured. But for simplicity, the image recording device 70 can be located so it can record a single image showing the deflection of shaft 34 between lower support 28 and support rollers 62. Advantageously, the image recording device 70 is between the undeflected and deflected locations of the shaft 34 at which the shaft properties are to be determined, and if properties at several locations are to be determined than the device 70 can be placed at several locations or placed at a single location deemed suitable for determining the properties at all locations. If the alignment of the undeflected shaft 34 is accurately set, then the optical axis 71 may be positioned more toward or at the location of the deflected position of the shaft 34 at which the properties are to be determined.

A digital camera preferably comprises the image recording device 70. The device 70 advantageously takes and records the image, but the image can be transmitted to a remote location, such as a computer 76 for storage and/or processing. The image transfer can occur immediately as by a wire or wireless transmission, or the transfer can be time delayed, as by transferring a storage media containing the image. As used herein, a computer includes an electronic processing unit that manipulates data and performs calculations suitable for the purposes described herein.

During use, the first end of the shaft 34 (e.g., grip end 48) is placed over second lower support 28 and below first upper support 26. The shaft 34 is thus placed between supports 26, 28. The location of the support 28 is optionally adjusted so the shaft 34 is at a predetermined orientation, preferably with the longitudinal axis 36 horizontal, or with the top or bottom of the shaft 34 at a defined orientation. One or more images of the deflection of the shaft 34 are then recorded by image recording device 70. Preferably a single image is recorded. The image recording device 70 may be linked by wires or wirelessly to a computer 76 having display 74. A laptop computer 76 or other computer is believed suitable. If the shaft position needs adjustment, the lower support 28 can be adjusted to vary the alignment of the shaft 34 and its longitudinal axis 36.

The opposing, second end of the shaft 34 (e.g., club end 47) is then bent downward and placed between rollers 72 while urging the first end against stop 24. The second end of shaft 34 is then released to be held in position by support 61 and rollers 62. The predetermined location of support 61 and rollers 62 should cause the shaft 34 to exert a predetermine force on support 61 and that force should be detected by force measuring device 66. The rotation of rollers 32 on supports 26, 28 and translation of roller 32 on shaft 28 should allow the shaft 34 to bend along a straight line without twisting the shaft, thus achieving a pure bending force on the shaft. A visual check of the force by display 68 should confirm the shaft performance is within acceptable criteria and verify correct installation in the testing apparatus. If the force is not correct and the shaft 61 is correctly installed and the supports 26, 28 and 61 are working correctly, then the location of support 61 can be adjusted using positioning mechanism 63 to vary the force. The adjustment can be made with the shaft 34 abutting support 61, or with the shaft disengaged from support 61.

One or more images of the deflection of the shaft 34 are then recorded by image recording device 70. Preferably a single image is recorded. If multiple images were recorded of the undeflected shaft, then preferably images of the deformed shaft are taken at the same locations as used for the undeflected shaft. Preferably, a single image is taken of the deformed shaft without moving the image recording device 70. The recordation of the image of the deflected shaft and the usefulness of that image are preferably verified, as by displaying the deflected image on a computer display 74 or by verifying each pixel has a color content typically represented by FF or 00 designations corresponding to the red, green or blue components of a color image recording device 70. Preferably, the image recording device 70 is a 24 bit device. More preferably, the pixel content reflects a grey scale value for ease of determining the number of pixels between corresponding locations on the shaft in the deformed and undeformed configuration.

The image(s) of the first shaft position, in the undeflected configuration, are compared with the image(s) of the second shaft position, in the deformed configuration. That comparison may give vertical displacement of the shaft 34 along the length of the shaft at each row and column of pixels, from which the deflection, slope and radius of curvature at various locations along the shaft may be determined. Thus, the images should also allow determination of the localized angle of deflection at various locations along the length of the shaft 34. The computer 76 can use the relative deflection information from the two images to calculate the deflection at various locations and to calculate the radius of curvature at various locations along the length of the shaft 34.

Ideally, the pixels of the digital recording device 70 can be used to determine the various shaft properties using the deflection, slope, and/or radius of curvature by tracking the number of pixels along the vertical Y axis to corresponding locations of the shaft 34, at two nearby locations on the shaft. Thus, a first image is recorded on digital recording device 70 with the shaft 34 in a loaded (deflected) or unloaded (undeflected) position, and a second image is then taken with the shaft 34 in the unloaded (undeflected) or loaded (deflected) position. The two images are then compared using the number of pixels to track the deflection at various points along the length of the shaft or using indicia or electronic values corresponding to the number of pixels to track the deflection at various points along the length of the shaft. The tracking, comparison and analysis is preferably performed by a computer or other processing system. The digital recording device 70 typically records information for each pixel providing various color and/or density values that that information may be used to determine the location of the shaft 34 and adjacent portions of the shaft.

For example, referring to FIG. 4, the curvature at any segment 80 along the length of deformed shaft 34 is determined by the change in the vertical distance y, denoted mathematically by dy, relative to the change in the distance x (dx), which is represented mathematically by dy/dx. The slope is:

dy/dx=(yp2−yp1)/(xp2−xp1)

The slope of the shaft 34 at each pixel 34 can be determined by determining the change in vertical pixels (for vertically upward or downward deflection) divided b the width of the pixel. From the slope, the radius of curvature can be determined since the radius of curvature is the inverse of the slope. The radius of curvature, 1/ρ(x), is approximated by the following equation when the deflection or elastic deformation of the club shaft 34 is small:

1/ρ(x)˜d²y/dx²

The smaller the distance dx, the more accurate the results. It is believed preferable to use a sensor on the image recording device 70 having about 16 million pixels, and preferable more. Cameras with 16 or more megapixel sensors with 24 bit, true color detection at the sensors, are commercially available. Such sensors may have individual pixels about 0.5 mm square in size.

By determining the number of pixels from corresponding portions of the shaft 34, and by knowing the size of the pixels, the vertical deflection and the slope at a location on the shaft 34 can be determined. If the pixels in the camera 70 are square, the number of pixels can be used to determine the slope, radius of curvature and deflection by calibrating the length of one pixel side to a corresponding distance on the shaft. For example, a shaft having a length GL of 38.5 inches which is recorded on a row of pixels 38,500 pixels long, corresponds to each pixel representing 0.001 inches. If the pixels are rectangular, then the dimension of the pixels must be used to adjust for the needed x and y dimensions and values to determine the slope at the selected location on the shaft. From the slope at the selected location on the shaft, the radius of curvature at that location can be determined, and the stiffness at that location can be determined.

Advantageously, the computer 70 has a memory in which is stored a suitable mathematical algorithm to sort through and identify the desired rows and columns of pixels corresponding to the desire shaft location before and after deformation, and then determining the slope, stiffness, radius of curvature and desired shaft properties at each selected shaft location, along portions of the shaft, or along the entire shaft. Common equations are believed suitable, such as the equation for deflection of a cantilevered beam, which assumes the supports 26, 28 provide a cantilever support for shaft 34. For relatively small deflections and loads or weights W a good approximation is provided. Similar approximations are described in U.S. Pat. No. 5,429,008, the complete contents of which are incorporated herein by reference. By using the slope, the deflection or the radius of curvature at a specific location along the length of the shaft 34, the stiffness at that location can be determined by using known equations that predict the curvature and deformation of beams under various loading conditions.

To make it easier for analysis the background is preferably a solid color readily separable or identifiable from the shaft 34. Lighting producing shadows is undesirable because it can make it more difficult to identify the edges of the shaft 34 on the image recording device 70. The slope, deflection etc. are preferably based on the centerline 36 of the shaft, which requires detecting opposing edges of the shaft 34 and then determining the midpoint of the shaft between those opposing edges and as appropriate, determining the deflection, slope and curvature at the midpoint location.

The deflection (y) for shaft 34 held by spaced apart supports 26, 28 at a location between the support 28 and the load can be analyzed as a cantilevered beam with a concentrated load at the free end of the beam as shown in FIG. 1, 3a, 6a or 8. A more precise calculation might use point supports at the location of supports 26, 28 and include the length of the shaft 34 between those supports 26. In either case, known equations exist for determining the deflection, slope and radius of curvature at various locations along the shaft 34 for various mounting configurations and load configurations. Those equations use the stiffness (EI) of the shaft 34. Since the image provided by image recording device 70 can be used to determine deflection and slope at a specific location on shaft 34, the stiffness can be determined using known equations. For illustration, the deflection y at a point x along on a cantilevered beam with a concentrated load W deforming the beam or shaft 34 is given by the equation:

y=Wx²(a₁−x)/6EI, where:

y=vertical deflection of shaft 34 at location x, measured between the fixed end of the shaft and the location of the load W

x=horizontal distance to location at which deflection y is determined

W=force (g or lbs) measured by force measuring device 66 or the applied weight W

a₁=the distance between support rollers 28 and the location of the weight W (m or in.)

E=Young's Modulus (N/m² or lb/in²)

I=Area moment of inertia (m⁴ or in⁴)

EI represents the shaft stiffness at location x. The illustrated equation, or other equations reflecting slope or deformation, can be solved by a computer or other device to determine the stiffness at a specific shaft location. The pixels can be manually counted by persons (in theory), but for practical purposes the number of pixels are electronically determined by suitable electronic devices using suitable electronic circuitry, including determining voltage differences or voltage values corresponding to the number of pixels in a row or column of the image array, or by using optical methods overlying images of deformed and un-deformed shaft 34. The geometric arrangement and distances from the image recording device 70, the location and orientation of optical axis 71, and the location, angles and distances to the various parts of the apparatus and shaft are known, so the physical distance the shaft 34 and its centerline 36 move are determinable using known geometric equations and methods. Because golf club shaft 34 is typically tapered, it is preferable to use the longitudinal axis 36 for deflection determinations.

The shaft 34 is assumed to deflect in a plane parallel to or substantially parallel to the backboard 20, thus simplifying the calculations to a two dimensional deflection. Thus, using the perpendicular distance along optical axis 71 of the image recording device 70 to the shaft 34 and the backboard 20 behind the shaft, and using the distance and/or angular location of the desired locations along the length of shaft 34 (and axis 36) and/or backboard 20 along a given line of sight, the geometry of the shaft 34 in the deflected and undeflected positions is known or determinable. By knowing the deflection at various locations along the length of the shaft 34 from the number of pixels, the deflection of the shaft 34 can be determined. Preferably, the deflection is determined by comparing the vertical location (deflection) of an edge of shaft 34 or the location of the axis 36, as determined by the first and second images recorded by device 70, and determining the difference in pixels between the location(s) in order to determine the shaft properties, as for example, by counting pixels or by having a computer identify pixels with color values corresponding to the background and/or to the shaft 34 various locations on the shaft.

The use of pixels on the image recorded by camera 70 is believed to be more accurate if the horizontal line of pixels in the sensor of a recording device 70 (such as a digital camera) is aligned with the longitudinal axis 36 when the axis 36 is used to determine slope. If the top or bottom edges of the shaft 34 are used for determinations, or if the horizontal pixels in the camera 70 are otherwise not aligned with the axis 36 in the undeflected configuration, then the location on the deflected shaft may vary by several pixels (or more) in the horizontal and vertical directions, depending on the number of pixels in the sensor of the image recording device 70. That variation in the accuracy of the deflection may be acceptable, and if not acceptable, is predictable and can be accounted for in the calculations. As long as the position and orientation of camera 70 are not altered between the undeflected and deflected positions, the effects of pixel alignment or misalignment will be minimal.

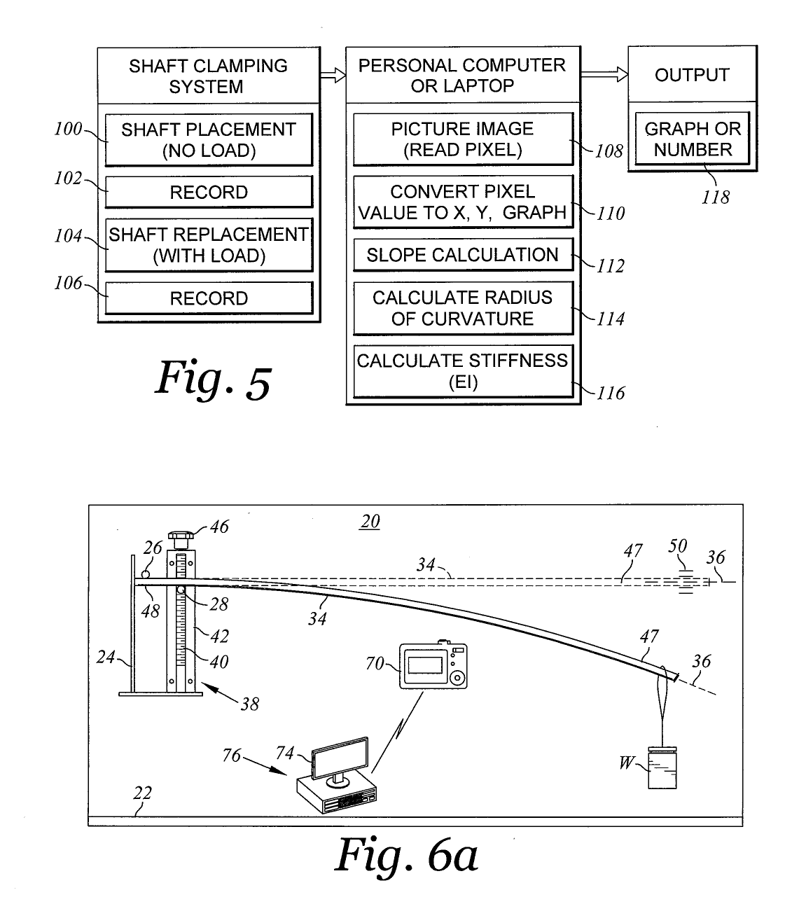

Referring to FIG. 5, a flow diagram of the method of determining the properties of shaft 34 is shown. In step 100, the one end of shaft 34 is placed onto supports 26, 28 and the horizontal alignment is optionally adjusted by moving support 26, 28 (preferably 28) to align centerline 36 with the horizontal axis. For illustration, the grip end 48 is shown held by supports 26, 28. This also sets the datum points defining the X and Y axes with the centerline 36 of the shaft 34 at the stop 24 and grip end 48. In step 102, the image of the un-deflected shaft 34 is recorded by image recording device 70, such as a digital camera.

In step 104, the shaft 34 is deflected by a known or predetermined force or a known or predetermine displacement causing a predetermined force. As needed, the predetermined force or displacement can be adjusted, as for example by varying the position of rollers 61 using adjustment mechanism 63. An image of the deflected shaft 34 is taken and recorded in Step 106.

In step 108, the image of the deflected shaft 34 is read into a computer or data processor. In step 110 the computer converts the X and Y pixels of the deflected image to X and Y deflection values or to representative values from which deflection can be determined. This step 110 may require comparing the initial un-deflected image with the deflected image to determine the appropriate baseline of X and Y values from which the deflected pixel location(s) are determined. The images or representations thereof may be overlaid or compared to determine the deflection and values used herein. The color signal values of each pixel can be used to help identify the shaft location, shaft edges, and the X or Y distance (in pixels) of various portions of the shaft 34 from the undeformed prosition. Commercially available software allows such overlaying and/or comparison, including Adobe Photoshop, if done visually. Advantageously, information is compiled reflecting the x-y position of the shaft along a length of the shaft corresponding to each pixel depicting the shaft, in an undeformed and deformed position. The information could be compiled relative to a first partially deformed position and a second, further deformed position.

In step 112, the slope at a selected X location(s) is determined by comparing the values of the pixels for the desired X and Y locations of the deflected location(s) relative to the undeflected location(s) or determining the number of pixels between a location in the deflected and undeflected position. Values representative of pixel locations could be used. Computer analysis of the image information in the various pixels facilitates this slope determination. The slope is preferably determined at the centerline 36 of the shaft as the edges of the shaft 34 may distort during deflection, or may become difficult to determine under fluctuating light conditions as may be provided by fluorescent lights. The centerline is determined as the midpoint between the edges along a straight line perpendicular to the un-deformed axis 36 and parallel to the backboard 20.

In step 114 the radius of curvature R at the selected location(s) is determined. In step 116, the stiffness of the shaft 34 at the selected location(s) is determined. In step 118, the value(s) for the slope, radius of curvature and stiffness, or any combination thereof, are output, preferably to display 74 associated with computer 76. The slope, radius of curvature and stiffness may be displayed numerically or graphically or any combination thereof, and may be stored in the memory of computer 118 or elsewhere, as in external memory, in optical devices such as CDs or DVDs, in jump drives, or in other storage devices for retention or transportation to computers and analysis. The shaft 34 can be rotated while in the deflected configuration in order to determine the spine of the shaft or to evaluate stiffness variations around a circumference of the shaft at various locations.

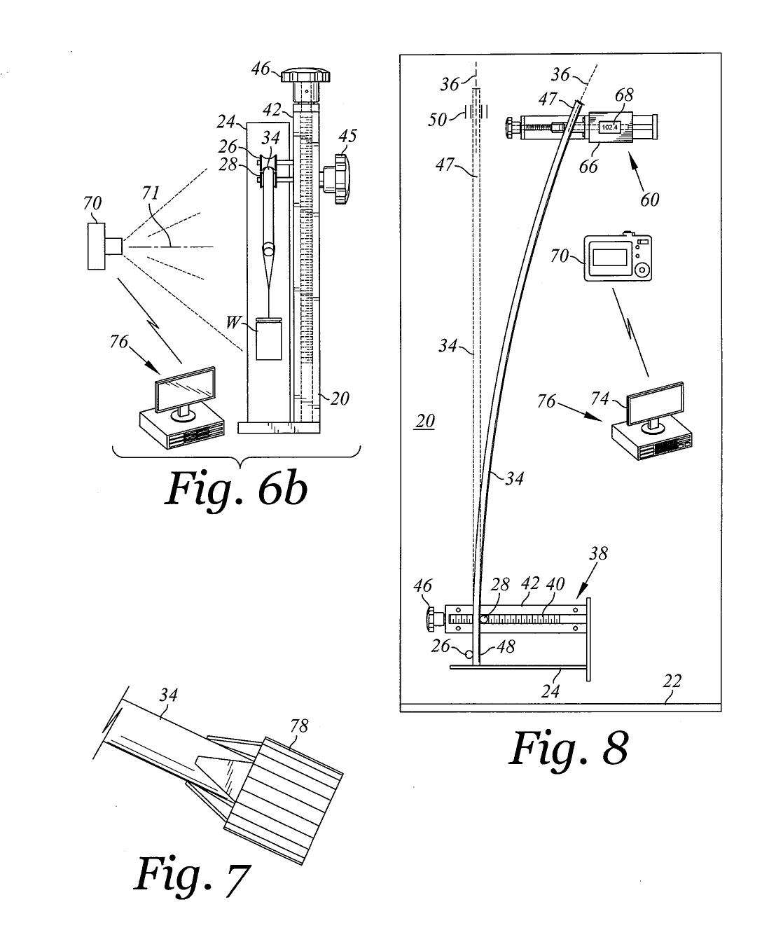

Referring to FIGS. 6a-6b, the displacement mechanism 60 is replaced by a weight W fastened to the shaft 34 at a predetermined location. The weight W may be fastened to the shaft by various means, including clamping a chuck 78 (FIG. 7) of a drill bit onto the end of the shaft. The jaws of the chuck are opened wide enough to fit onto the end (47 or 48) of the shaft 34 and then tightened to clamp onto the shaft sufficiently to keep the chuck (weight W) from sliding on the shaft 34 but not tight enough to cause damage to the shaft 34. Other fastening mechanism can be used, including rings, flexible loops (FIGS. 6a-6b), and other clamping mechanisms. If the deflection of shaft 34 is not great then the tendency of the weight W to slide off the end of the shaft allows more flexibility in the nature of the mechanism for attaching the weight W to the shaft. Thus, lighter weights W or placing the shaft more toward the support 28 allow more flexibility in deforming the shaft using weights W.

The method of determining the deflection of shaft 34 using a suspended weight W (rather than deflection) is the same as describe above, except that the position of the weight W on the shaft 34 in the deflected configuration is also optionally recorded on the image taken by the image recording device 70. If the weight W is applied at a predetermined location(s) then the image may verify that the weight W is in the correct position(s). If the weight W is not at a predetermined location, then an appropriate adjustment to account for the weight W along the length of the shaft 34 can be made.

In the above description the rollers 32 have a groove around the radial periphery of the roller with a curved cross-section section within which the shaft 34 rests. Advantageously, the radius of curvature of that groove is semicircular and preferably slightly wider than the diameter of the shaft 34 abutting the roller. Since the shaft 34 can be inserted into the supports 26, 28 with either end 47, 48 abutting the stop 20, the groove in the rollers 32 are preferably large enough to accommodate the grip end 48. Alternatively, the testing device can be used with the shaft 34 consistently in one orientation and the grooves in the rollers 32 on supports 26, 28 can differ in size according to the size or range of sizes of shafts 34 to be placed against the rollers.

The position adjustment mechanisms 38, 60 are described as using a lead screw. But other adjustment mechanisms can be used, including a straight rack gear and pinion, preferably with the rack gear mounted along backboard 20. Other linear positioning mechanisms may also be used, including balls screws, pulleys mechanisms, set screws, friction locking screws releasably abutting a sliding support, belt mechanisms, gear mechanisms and various other positioning mechanisms known to those skilled in the art of linear positioning devices.

The above description is given with the shaft 34 oriented horizontally. Referring to FIG. 8, the shaft 34 is vertically oriented with the displacement mechanism 60 to one side of the shaft 34. By adjusting for the 90° shift in orientation the above description using FIGS. 1 and 3 applies to FIG. 8, recognizing that relative terms such as up, down, above, below, upper, lower may change to left or right, depending on viewing direction and/or orientation. If a weight W is used with the undeflected shaft 34 in the vertical orientation, then pulleys will be needed to pull the shaft laterally in the horizontal plane since the weight W would slide along the length of the axis if the weight were vertically connected to a vertical oriented shaft 34. If the shaft 34 is inclined to the horizontal and a weight W is used to cause the deflection, then suitable adjustments for the direction of the force exerted by weight W and for any pulleys must be made in the resulting calculations of slope, radius of curvature, and stiffness.

In the above descriptions the shaft 34 is bent out of a straight line, but preferably remains bent in a single plane generally depicted in the figures as the horizontal and vertical X-Y plane. The camera 70 is offset from that plane a suitable distance, and located at a position a suitable distance, which distances are sufficient to capture the deflection of that portion of the shaft 34 for which the shaft properties are to be determined. The image advantageously includes the un-deflected and the deflected configurations of the shaft 34, but if the shaft 34 can be accurately aligned in the un-deflected configuration to establish a consistently repeated baseline location, then only the deflected configuration of the shaft may be recorded. In this later use, the optical axis 71 of the digital image recording device 70 may advantageously be aligned with the location of the top edge, bottom edge or longitudinal axis of that part of the shaft 34 for which the properties are to be determined.

The shaft 34 extends in a straight line in its undeflected configuration, especially if the effects of gravity and shaft orientation are not considered. That straight line is defined by the location of the first and second supports 26, 28. The third support 61 causes the shaft 34 to bend into a deflected configuration about second support 28 which is located between the supports 26, 61. Viewed differently, the shaft 34 abuts supports 26, 28 located toward opposing ends of the shaft 34 to define a straight line. The location of the second support 28 between the first and third supports 26, 61 causes the shaft to bend and determines the amount of deflection of the shaft 34. The shaft 34 abuts the lower portion of supports 26, 28 in the particular orientation and location used in FIG. 1 and gravity would cause the shaft to fall away from those supports, which is one reason why the location of the first two supports 26, 28 are preferably set first when the testing apparatus is oriented and arranged as shown in FIG. 1. But as is apparent from the above description, the deflection of shaft 34 could be achieved in various ways by locating the supports 26, 28, 61 and weight W in various arrangements and sequences or by merely deforming the shaft without using weight W.

Preferably, the shaft 34 deflection is determined at two or more orientations about the longitudinal axis of the shaft since portions of the shaft may not be symmetrical and may be out of round. Thus, the shaft 34 is advantageously tested, rotated 45° or 90° in either direction, and then retested to see if the properties of shaft 34 remain consistent, or consistent within an acceptable range.

Further, the above description supports the shaft 34 with the butt end 48 held by supports 26, 28. The shaft 34 can be reversed with the club end 47 held in supports 26, 28 and the deflection test repeated. The same points or locations on the shaft 34 should have the same stiffness regardless of which orientation the deflection occurs. Reversing the orientation of the shaft can thus verify the shaft stiffness.

As indicated above, the image recording device 70 and the resulting pixel images may also be used as an image comparator in which an image from the recording device 70 of a shaft 34 deflected under a known weight applied at a predetermined location is compared to a reference image to determine if the shaft properties are within an acceptable range. The difference(s) in the number of pixels between comparable locations on the upper or lower edges (or calculated centerline) of the deflected shaft and the reference shaft can be used to evaluate the above noted shaft properties. The shaft may be rotated a predetermined number of degrees (e.g., 45° or 90°) about its longitudinal axis and then retested to evaluate any asymmetric shaft properties. These differences in deflection, measured in pixels, need not be done visually, but may be performed by computer calculation, with various forms of output, including, but not limited to numbers of pixels at one or more shaft locations, offset distance from desired values at one or more shaft locations (e.g., in inches or mm), normalized values, property values (for the shaft 34 or at one or more locations along the shaft—such as stiffness) or simply acceptable or non-acceptable shaft properties.

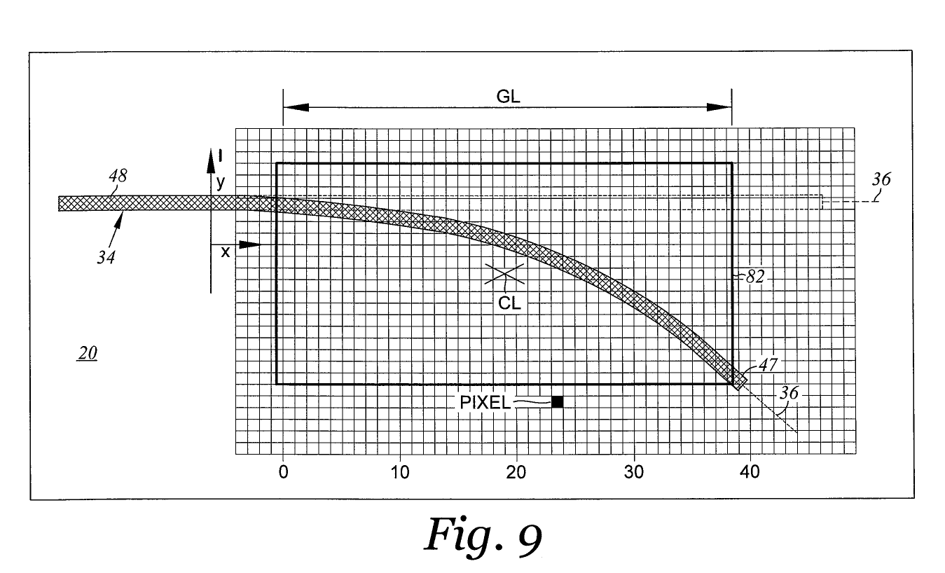

Referring to FIG. 9, the un-deformed position of shaft 34 is shown in dashed lines, with the position of the same shaft deformed by a weight W is also shown in solid lines. An image of each shaft position is recorded in device 70, with the image represented by the grid work which represents pixels in sensor of the recording device 70. The sensor of the device 70 is typically rectangular and is preferably positioned so that it includes the distal end or club end 47 of the shaft 34 at one corner (lower right in FIG. 9) and captures a portion of the butt end 48 of the shaft in a diagonally opposing corner (upper left in FIG. 9) of the sensor. In order to maximize the use of the pixels the rectangular field of sensors has its upper edge along or adjacent to the upper edge of the un-deflected shaft 36 and its sensor edge at or adjacent to a shaft location at which the deformation, slope or stiffness is to be determined.

For illustration purposes a darkened rectangle 82 is marked to reflect the sensor field of recording device 70. The sensor is typically centered on the optical axis of the recording device 70, and the optical axis is preferably located along an axis passing through the center of the rectangular area bounded by sensor 82 and which is marked CL in FIG. 9. The optical axis is preferably perpendicular to the plane in which the shaft 34 is deformed or deflected. For calibration, the gage length (GL), which is the physically distance corresponding to the sensor field 82, can be physically measured and correlated to the number of pixels extending along that gage length GL, in order to provide a dimension for each pixel. In FIG. 9, there are about 38.5 pixels in the Gage length, measured along the x axis. The actual sensor of recording device 70 will have several million pixels so FIG. 9 is for illustration only. But the gage length allows calibration to correlate actual pixel dimensions to actual deflection of the shaft 34. A resolution of abut 0.5 mm per pixel or smaller is preferred.

It is desirable that the backboard 20 have a contrasting color to the shaft 34 to make it easier to monitor the movement of shaft 34. A constant light source such as a tungsten light, is also preferred. Florescent lights fluctuate at a rate invisible to the eye but detectable by digital sensors used in cameras. Shadows on the backboard 20 cast by shaft 34 are undesirable. Fixed lenses are preferred over zoom lenses, with one or both of the device 70 and shaft 34 being moved relative to each other to encompass the desired shaft deflection in the sensor range. A stable mount for the image recording device 70 is preferred to avoid camera jitter.

The supports 26, 28 provide a two point support for the shaft 34 that allows a more accurate analysis of the bending forces and deflection of the shaft 34, compared to a gripping mechanism that clamps an end of the shaft 34. This is especially so when the shaft 34 deflects in a single plane, and that is easily achieved by appropriate alignment of supports 26, 28 and 61, or by allowing one or more of the supports to move orthogonally to the plane in which the shaft 34 is bent. The supports 26, 28 also allow the shaft 34 to be quickly inserted into and removed from the test apparatus and that allows improved efficiency. The use of a displacement mechanism 60 reduces the settling time and also allows faster testing and improved efficiency. The use of an adjustment mechanism to vary the relative location of the supports 26, 28 allows fast adjustment and alignment of the un-deflected shaft position. The use of an adjustment mechanism on the deflection mechanism 60 allows the deflecting force exerted on an end of the shaft 34 to be varied, and also improves efficiency.

The supports 26, 28 provide a means for supporting shaft 34 at a first end of the shaft along a first axis, preferably the horizontal X axis or vertical Y axis, and preferably with the longitudinal axis 36 aligned with that first axis. The weight W and displacement mechanism 60 provide means for deflecting the shaft 34 into a bent configuration. The digital image recording device 70 provides means for taking a digital image of the bent configuration during use of the apparatus; and the device 70 and computer 76 provide am means for recording that digital image. The computer 76 and any of various analytical algorithms provide means for using the number of pixels in the digital image to determine one of the slope, radius of curvature or stiffness of the shaft 34 at least at one location on the shaft. The support 60 also provides means for displacing the second end of the shaft 34 a predetermined distance. The force measuring device 66 provides means for detecting the amount of force the shaft 34 exerts on a support 61 holding the shaft in the bent configuration. The force measuring device 66 could be placed on the first or second supports 26, 28, but accuracy is believed to be improved if it is used on the second end of the shaft as shown in the figures. The supports 26, 28 also provide means for supporting the first end of the shaft 34 between two rollers located on opposing sides of the first end of the shaft and offset from each other along a length of the shaft. The adjustable positioning mechanisms 38 provides means for varying the relative location of the two supports and/or two rollers 32 in order to vary the inclination of the longitudinal axis 36 of the shaft 34 and to align the shaft in a desired orientation.

The above description is given by way of example, and not limitation. Given the above disclosure, one skilled in the art could devise variations that are within the scope and spirit of the invention disclosed herein, including various ways of deflecting the shaft 34 or holding the shaft relative to the image recording device 70, or various locations to place image recording device 70, or various formulas for calculating properties of the shaft 34. Additionally, the supports 26, 28 are described as fastened to backboard 20, but may be mounted otherwise, including being mounted on separate brackets positionable relative to each other. It is desirable to have the supports 26, 28 and 61 accurately positioned relative to each other, and thus it is desirable to have them in a fixed location for consistent and reproducible testing of shaft 34. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A test apparatus for golf club shafts which have a grip end opposite a head end and further having a length of the shaft extending between those two ends along a longitudinal axis, the test apparatus comprising:
first and second supports spaced apart along first and second perpendicular axes with the spacing along the first axis being larger than a diameter of the shaft at the second support and sufficient to provide a two point cantilever support and with the spacing along the second axis being about the diameter of the end of the shaft at the supports, the supports arranged to hold the shaft along the first axis in an unloaded and undeformed position;
a third support located along the first axis a distance less than a length of the shaft 34 to place the second support between the first and third supports along that first axis, the third support located a predetermined distance from the second axis to place the second support offset from a line between the first and third supports so that during shafts with one end of the shaft placed between the first and second supports can have the other end of the shaft bent over the second support and held in the bent configuration by the third support;
a first position adjustment mechanism connected to one of the first and second supports for adjusting the relative position of the first and second supports along the second axis so that during use an end of the shaft placed between the first and second supports can extend along the second axis with inclination of the shaft relative to the second axis being adjusted by the first positioning adjustment mechanism;
a digital image recording device producing a pixilated image, the recording device offset from a plane containing the first and second axes and placed at a location suitable to record the bent configuration of at least a portion of the shaft during use of the apparatus
a computer comparing data from digital images of the shaft in a first position and in a second deformed position to determine one of the slope, deflection or radius of curvature of the shaft at a location on the shaft.

2. The testing apparatus of claim 1, wherein the first position adjustment mechanism is connected to the second support, and further comprising a stop adjacent the first support to limit motion of the shaft along the first axis during use of the apparatus.

3. The testing apparatus of claim 2, further comprising a force detecting device connected to the third support to detect the force exerted by the shaft on the third support when the shaft is in the bent configuration.

4. The testing apparatus of claim 3, further comprising a second position adjustment mechanism connected to the third support for adjusting the position of the third support along the second axis.

5. The testing apparatus of claim 2, wherein the image recording device is positioned to record that portion of the shaft between the grip and the club the during use of the apparatus.

6. The testing apparatus of claim 2, further comprising rollers on a plurality of the supports, at least one of the rollers further being movable along an axis orthogonal to the first and second axes.

7. The testing apparatus of claim 2, further comprising rollers on the first and second supports which rotate about an axis orthogonal to the first and second axes, each roller having a groove around a periphery of the roller which groove is selected to have a diameter larger than the diameter of the shaft abutting the groove during use of the testing apparatus, at least one of the rollers further being movable along an axis orthogonal to the first and second axes.

8. The testing apparatus of claim 2, wherein the computer determines one of the deflection, slope, radius of curvature or stiffness of the shaft at least at one location on the shaft using the number of pixels from the digital image recording device for such determination.

9. The testing apparatus of claim 2, wherein the computer uses digital images of a first undeflected configuration where the shaft is supported by the first and second supports and a second bent configuration, the computer using the number of pixels from the digital image recording device for such determination.

10. The testing apparatus of claim 2, wherein the determined information is used to further determine the shaft bending stiffness.

11. A test apparatus for golf club shafts which have opposing first and second ends and further having a length of the shaft extending between those two ends along a longitudinal axis, comprising:
first and second spaced apart support means for supporting the shaft at a first end of the shaft along a first axis during use of the apparatus;
means for deflecting the shaft into a bent configuration during use of the apparatus;
means for recoding a digital image of the shaft in two configurations during use of the apparatus, one of which is the bent configuration; and
means for comparing pixels in the digital images to determine at least one of the shaft deflection, radius of curvature, slope or stiffness.

12. The test apparatus of claim 11, wherein the means for deflecting the shaft comprises a displacement mechanism that bends the shaft a predetermined distance from the first axis.

13. The test apparatus of claim 12, further comprising adjustable means for varying the relative location of the first and second means to vary the inclination of the first axis.

14. The test apparatus of claim 12, further comprising adjustable means for varying the location of the third means relative to the second means.

15. The test apparatus of claim 12, further comprising means for detecting the force exerted by the bent shaft on the third means.

16. The test apparatus of claim 15, further comprising adjustable means for varying the relative location of the first and second means to vary the inclination of the first axis, adjustable means for varying the location of the third means relative to the second means, and means for detecting the force exerted by the bent shaft on the third means.

17. A method for testing a golf club shaft having opposing first and second ends and further having a length of the shaft extending between those two ends along a longitudinal axis, comprising:
supporting the shaft at a first end of the shaft along a first axis;
recording a first digital image of the shaft along the first axis;
deflecting the shaft into a bent configuration;
recording a second digital image of the bent configuration;
comparing information from the pixels the first and second images to determine one of the slope, radius of curvature or stiffness of the shaft at least at one location on the shaft; and
using the one of the determined slope, radius of curvature or stiffness of the shaft to determine acceptability of the shaft for use in golf clubs.

18. The method of claim 17, wherein the deflecting step comprises displacing the second end of the shaft a predetermined distance.

19. The method of claim 17, wherein the deflecting step comprises releasably fastening a known weight to the shaft to cause the deflection.

20. The method of claim 17, wherein the deflecting step comprises displacing the second end of the shaft a predetermined distance and further comprising detecting the amount of force the shaft exerts on a support holding the shaft in the bent configuration.

21. The method of claim 20, wherein the supporting step comprises supporting the first end of the shaft between two rollers located on opposing sides of the first end of the shaft and offset from each other along a length of the shaft.

22. The method of claim 21, further comprising varying the relative location of the two rollers to vary the inclination of the longitudinal axis of the shaft.

23. The method of claim 21, further comprising varying the location of the third support relative to each of the two rollers.

24. The method of claim 21, further comprising detecting the force exerted by the bent shaft on a support which displaces the shaft.

25. The method of claim 21, further comprising the steps of:
rotating the shaft a predetermined amount;
deflecting the shaft into a bent configuration;
recording a digital image of the bent configuration during use of the apparatus; and
using the number of pixels in the digital image to compare a shaft property with a reference value.

26. The method of claim 17, wherein the comparing step compares the pixels in the first and second images to determine the slope of the shaft at least at one location.

27. The method of claim 17, wherein the comparing step compares the pixels in the first and second images to determine the deflection of the shaft at least at one location.

28. The method of claim 17, further comprising:
using the one of the determined slope or radius of curvature to determine a first stiffness of the shaft at least at a first location.

29. The method of claim 18, further comprising:
reversing the orientation of the shaft and performing the defined steps of claim 18 to determine a second stiffness value at the first location; and
comparing the first and second stiffness.
